(19) United States
(12) Patent Application Publication
(10) Pub. No.: US 2006/0038496 A1
(43) Pub. Date: Feb. 23, 2006

(54) Gas discharges having emission in UV-A range and fluorescent lamps incorporating same

(75) Inventors: Joseph Darryl Michael, Schoharie, NY (US); Nikolai Alexandrovich Timofeev, St-Petersburg (RU); Mikhail Alexeevich Khodorkovskii, St.-Petersburg (RU)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/077,567

(22) Filed: Mar. 11, 2005

(30) Foreign Application Priority Data
Aug. 17, 2004 (RU) 2004125185

(51) Int. Cl. H01J 17/20

(52) U.S. Cl. 313/643

(57) ABSTRACT

A mercury-free EM radiation source comprises excited oxygen-, nitrogen-, or carbon-containing radicals emitting radiation in the wavelength range from about 254 nm to about 410 nm. A light source comprises such an EM radiation source and at least a photoluminescent material that is capable of being excited by the EM radiation emitted by the source, and emitting EM radiation in the visible wavelength range.

### BACKGROUND OF THE INVENTION

The present invention relates to discharge lamps having a source of emission in the wavelength range in the UV-A radiation. In particular, the present invention relates to fluorescent lamps having a gas discharge UV-A radiation source and emitting in the visible electromagnetic spectrum.

Mercury vapor discharge fluorescent lamps have been used extensively for lighting purposes. In such lamps, a small amount of mercury and an inert gas, such as argon, krypton, or xenon, are contained in a sealed glass tube having an electrode at each of its ends. During operation, a discharge is generated between the electrodes, and the mercury atoms are excited to a high-energy state. Upon returning to the ground state, the mercury atoms produce ultraviolet (“UV”) radiation, which consists essentially of emission at 254 nm and 185 nm. In order to convert this UV radiation to useful light in the visible wavelength range, one or more phosphors are provided on the inner wall of the glass tube to absorb this UV radiation and emit in the wavelength range. The terms “light” and “electromagnetic (‘EM’) radiation” without a qualifier are used herein interchangeably to denote EM radiation having wavelengths in the range from about 100 nm to about 1 mm. UV-A means UV radiation having wavelengths in the range from about 300 nm to about 400 nm.

The energy efficiency of mercury vapor discharge fluorescent lamps are low because of the large difference between the wavelengths of radiation emitted by mercury and those of light emitted by the phosphors. In addition, mercury in lamps that are finally discarded presents a source of pollution.

U.S. Pat. No. 6,040,658 describes a mercury-free discharge lamp wherein UV-A emission having wavelength of about 306 nm is obtained from excited OH radicals, which are formed from dissociation of alkali earth metal hydroxides, such as Ca(OH)₂ or Mg(OH)₂, or of water vapor. Although the emission of excited OH radicals is closer to the visible emission of most useful phosphors than that of mercury, there still is a large difference.

Therefore, it is desirable to provide a source of exciting radiation having wavelength closer to the emission of useful phosphors. In addition, it is also desirable to provide fluorescent lamps incorporating such a source of radiation for improved energy efficiency.

### SUMMARY OF THE INVENTION

The present invention provides a mercury-free EM radiation source emitting radiation in the wavelength range from about 254 nm to about 410 nm. In particular, the radiation source emits in the wavelength range from about 300 nm to about 400 nm.

According to one aspect of the present invention, a light source comprises an EM radiation source emitting first EM radiation in the wavelength range from about 254 nm to about 410 nm, and at least a photoluminescent material excitable by the first EM radiation to emit a second EM radiation in the visible wavelength range.

According to another aspect of the present invention, visible light is generated by a method that comprises: (a) providing an EM radiation source emitting first EM radiation in the wavelength range from about 254 nm to about 410 nm; and (b) disposing at least a photoluminescent material that absorbs the first EM radiation and emits a second EM radiation in the visible wavelength range.

Other features and advantages of the present invention will be apparent from a perusal of the following detailed description of the invention and the accompanying drawings in which the same numerals refer to like elements.

### BRIEF DESCRIPTION OF THE DRAWINGS

FIG. 1 shows the emission spectrum of a gas discharge source containing Ar, H₂O, and N₂ when an electrical potential is applied thereto.

FIG. 2 shows the emission spectrum of a gas discharge source containing Ar, H₂O, and N₂ at 5 minutes after an electrical potential being applied thereto.

FIG. 3 shows the emission spectrum of a gas discharge source containing Ar, H₂O, and N₂ at 7 minutes after an electrical potential being applied thereto.

FIG. 4 shows the emission spectrum of a gas discharge source containing Ar, H₂O, and N₂ at 9 minutes after an electrical potential being applied thereto.

FIG. 5 shows the emission spectrum of a gas discharge source containing Ar, H₂O, and N₂ at 25 minutes after an electrical potential being applied thereto.

FIG. 6 shows the emission spectrum of a gas discharge source containing Ar, H₂O, and N₂ at 30 minutes after an electrical potential being applied thereto.

FIG. 7 shows the emission spectrum of a gas discharge source containing Ar, H₂O, and N₂ at 35 minutes after an electrical potential being applied thereto.

FIG. 8 shows schematically a light source that can use a mercury-free EM radiation source of the present invention.

### DETAILED DESCRIPTION OF THE INVENTION

The present invention provides a mercury-free EM radiation source emitting radiation in the wavelength range from about 254 nm to about 410 nm. In particular, the radiation source emits in the wavelength range from about 300 nm to about 400 nm. The radiation source is a gas discharge containing materials that are capable of generating at least one of oxygen-, nitrogen-, and carbon-containing radicals. In one embodiment, these radicals are generated by bombarding materials containing oxygen, nitrogen, or carbon with charged species that may be generated by, for example, an electrical discharge or a high-frequency EM field. The radicals in the discharge are in high-energy excited state, emitting EM radiation upon returning to a lower energy state. Non-limiting examples of high-energy radicals that emit EM radiation in the range from about 254 nm to about 400 nm are OH, CO, CO⁺, CO₂⁺, CN, CN⁺, NH, NO, N₂O⁺, and C₂. These radicals exhibit strong emission at the wavelength shown in Table 1, which also shows exemplary sources for the particular species.

TABLE 1

| | Strong Emission | |
|---|---|---|
| Species | Wavelength (nm) | Source |
| OH | 306 | water vapor, dissociation of |
| | | alkali metal hydroxides |
| CO | 283, 298, 313, | CO in discharge tubes |
| | 389, 412 | |
| CO⁺ | 360, 371, 372, | discharge tubes containing CO, |
| | 380, 402 | CO/He, CO₂, electron beam |
| | | bombardment of CO |
| CO₂⁺ | 337, 338, 355, | discharges through CO₂ |
| | 362 | |
| CN | 359, 386, 387, | discharge tubes containing |
| | 388, 422 | nitrogen and carbon compounds, |
| | | carbon compounds reacting with |
| | | active nitrogen |
| CN⁺ | 302, 306, 326 | discharge in He containing |
| | | traces of C₂N₂ |
| NH | 336, 337 | ammonia/oxygen, H₂/N₂O, |
| | | active nitrogen |
| NO | 339, 358, 380 | discharge tubes containing |
| | | oxygen and nitrogen, nitrogen |
| | | afterglow |
| N₂O⁺ | 356, 371 | Hollow cathode discharge or |
| | | electron beam through N₂O |
| C₂ | 340, 359, 363, | Discharge through CO, CO₂, |
| | 407, 410 | C₂H₂, He/C₆H₆ |

(See; e.g., R. W. B. Pearse and A. G. Gaydon, “The Identification of Molecular Spectra,” Chapman and Hall, London, 1976.)

### EXAMPLE

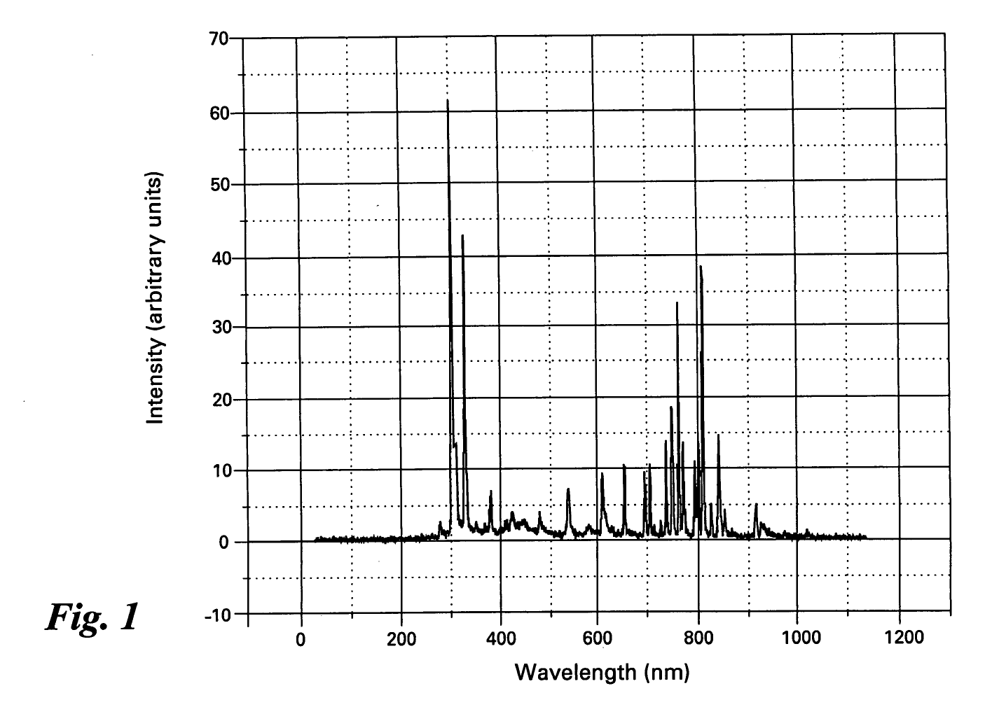

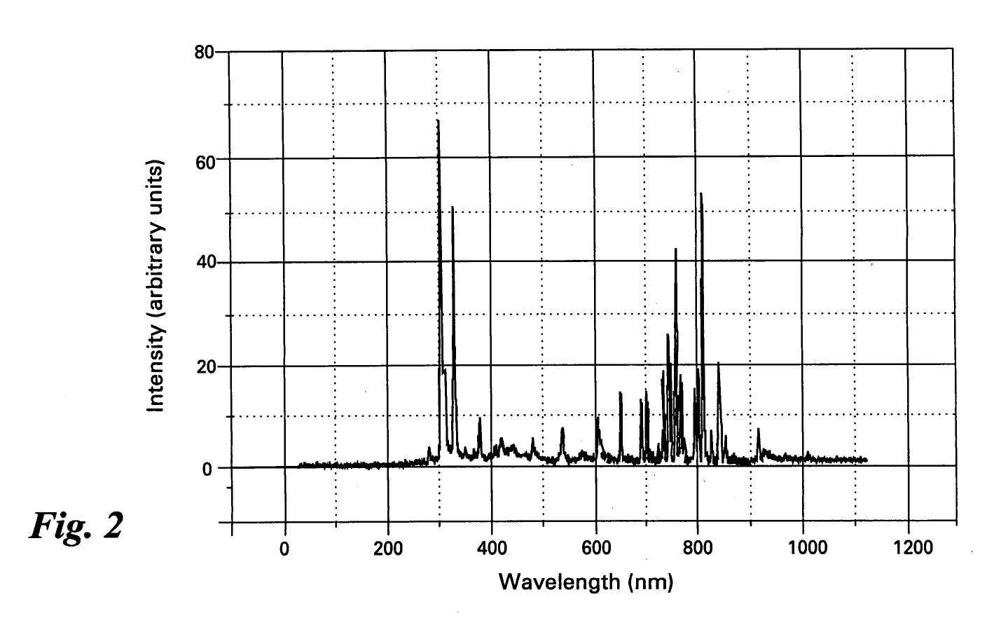

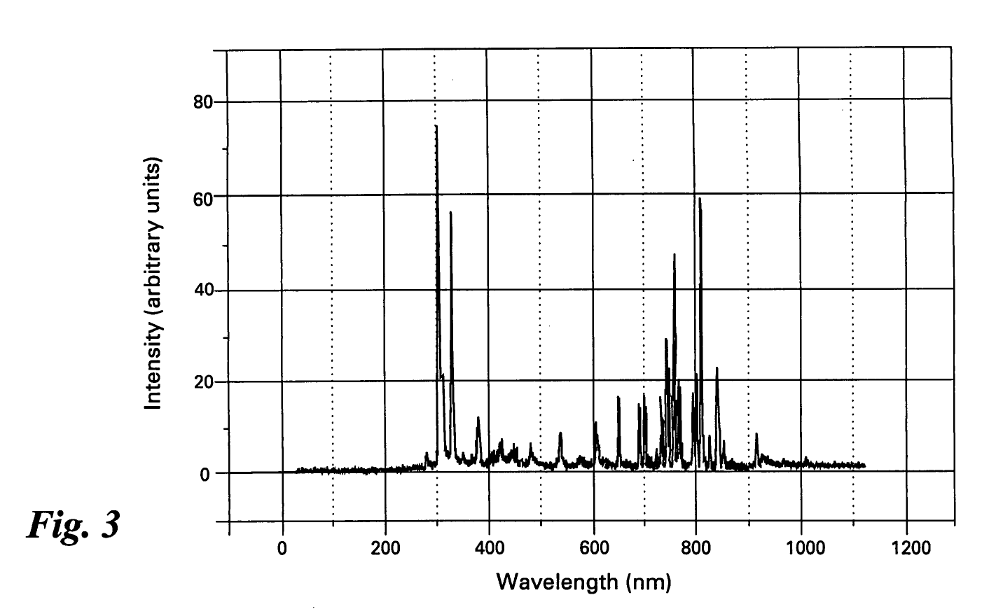

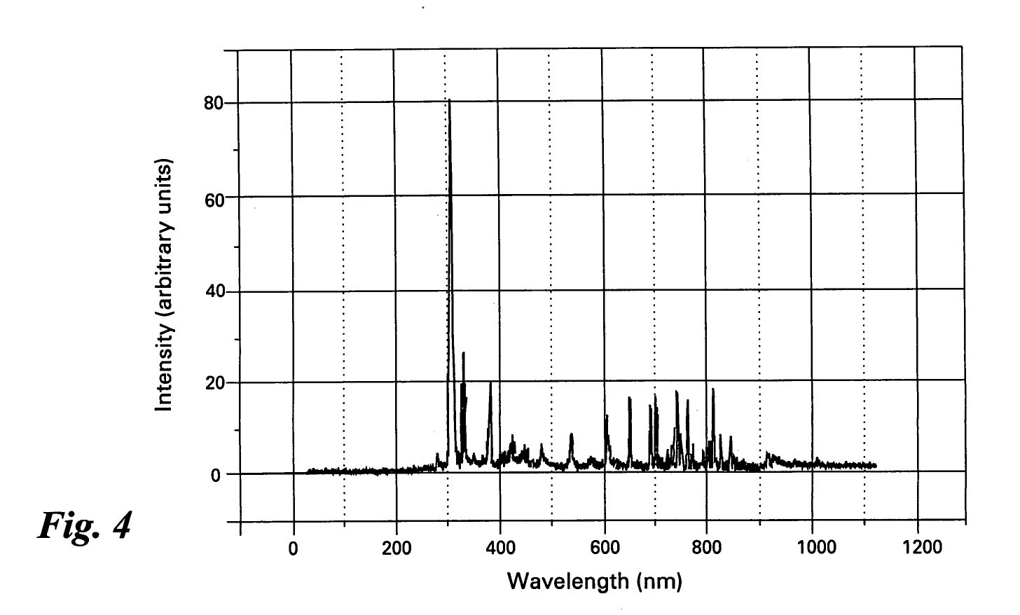

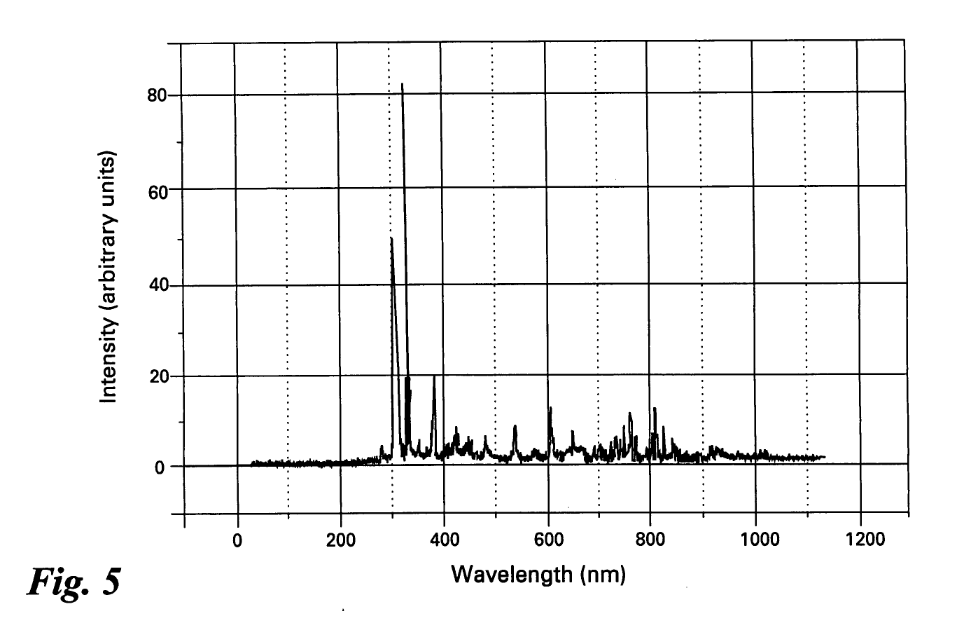

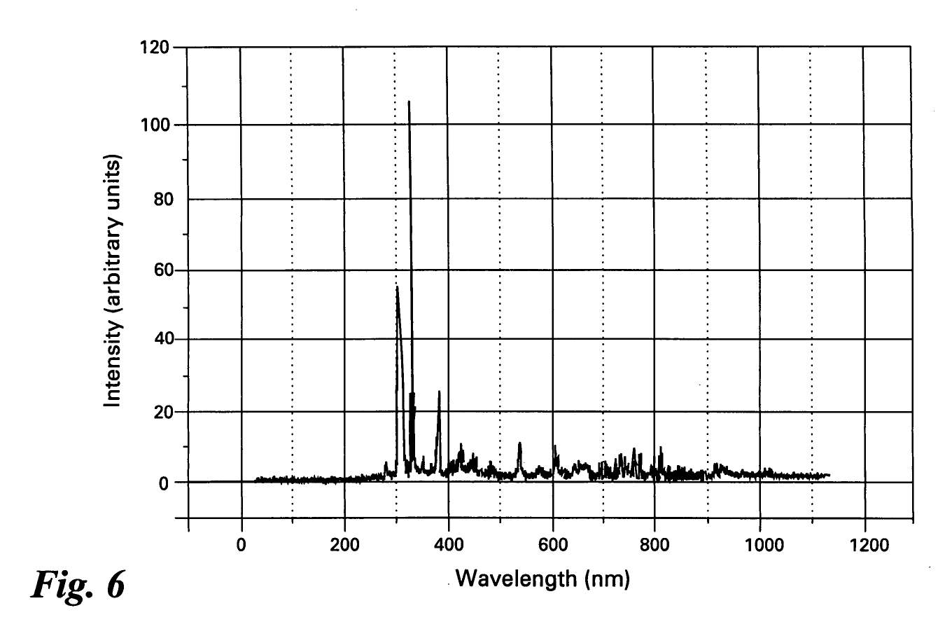

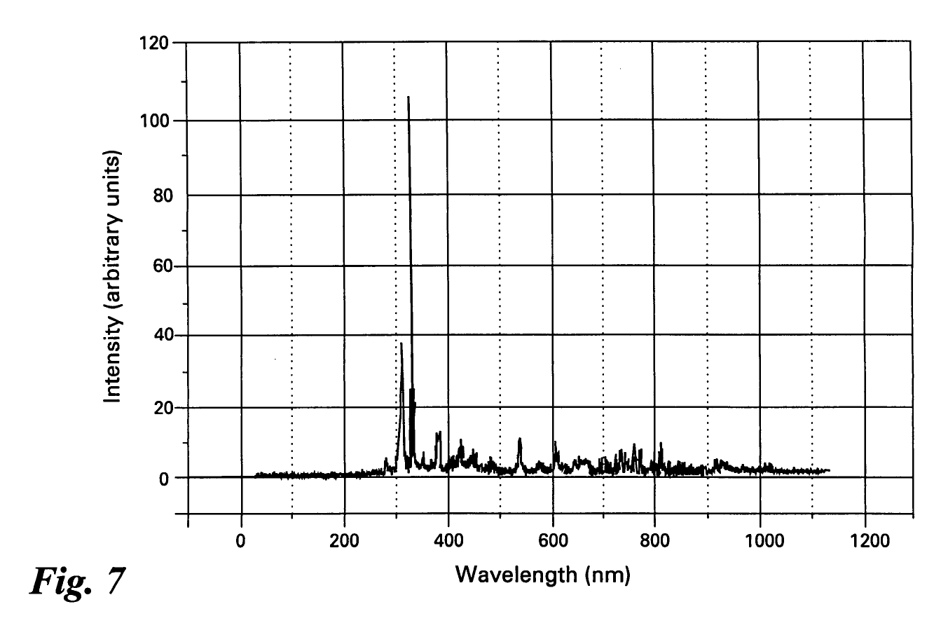

A fluorescent lamp tube with associated electrodes was evacuated, and then filled with argon, nitrogen, and water vapor, each having an individual vapor pressure of about 2 torr (or 267 Pa), 0.2 torr (or 26.7 Pa), and 0.2 torr (or 26.7 Pa), respectively. An electrical discharge was established in the tube, and emission spectra were obtained at time 0, 5, 7, 9, 25, 30, and 35 minutes after an electrical potential of 200 V was applied to the electrodes. The emission spectra are shown in FIGS. 1-7. Strong emission is observed at wavelengths of about 306 nm and 336 nm, characteristic of emission from OH and NH radicals, respectively. Emission from these excited radicals continued well after the emission from high-energy argon had essentially stopped.

Mercury-free fluorescent lamps using at least one of the excited radicals disclosed above as the source of exciting radiation for photoluminescent materials (or phosphors) can improve the energy efficiency of fluorescent lamps because the wavelength of exciting radiation is closer to the phosphor emission wavelength (smaller Stokes shift) than the wavelength of mercury vapor discharge. In addition, phosphors can be selected that strongly absorb exciting radiation from a particular high-energy radical, further increasing the lamp energy efficiency. Many such phosphors absorb strongly in the wavelength range from about 300 nm to about 410 nm, and thus have not been optimally used in conjunction with the mercury emission at 254 nm in conventional mercury discharge-based fluorescent lamps. Non-limiting examples of such phosphors are (1) the blue emitting phosphors (Sr,Ca)₁₀(PO₄)₆Cl₂:Eu²⁺; Sr₂P₂O₇:Eu²⁺; (Sr,Mg)₂P₂O₇:Eu²⁺; and Ba_{0.07}Mg₂Al_{z}O_{3/2z+3}:Eu_{0.13}²⁺, where 14≦z≦25; (2) the green emitting phosphors 2SrO.0.84P₂O₅.0.16B₂O₃:Eu²⁺; Sr₂Si₃O₈.2SrCl₂:Eu²⁺; Sr₄Al₄O₂₅:Eu²⁺; and Ba_{0.8}Mg_{1.93}Al₁₆O₂₇:Eu_{0.2}²⁺,Mn²⁺; (3) the green-yellow emitting phosphor Y₂SiO₅:Ce³⁺,Tb³⁺; and (4) the red emitting phosphors 6MgO.As₂O₅:Mn⁴⁺ and 3.5MgO.0.5MgF₂.GeO₂:Mn⁴⁺.

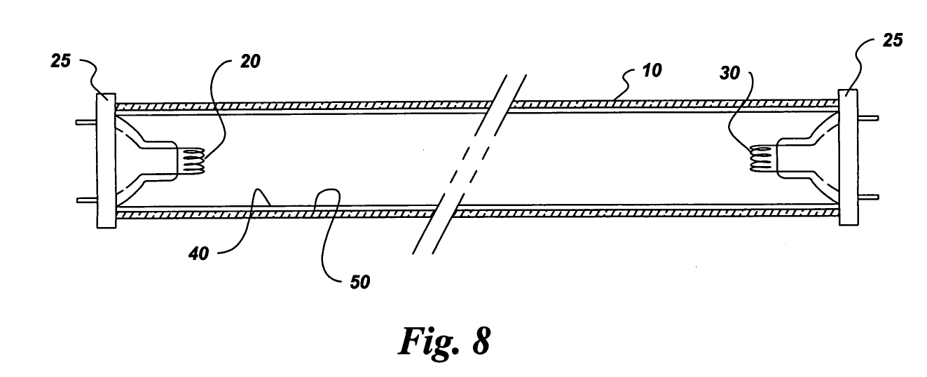

In one embodiment, the construction of a mercury-free fluorescent lamp of the present invention is similar to that of a conventional fluorescent lamp. FIG. 8 schematically shows such a lamp. An envelope 10 comprising an optically transparent material, such as glass, is provided with electrodes 20 and 30 comprising a material capable of emitting electrons, such as tungsten, and an end cap 25 at each end. The term “optically transparent” in this disclosure means allowing at least 80 percent of light having wavelengths in the range from about 400 nm to about 800 nm to pass through a specimen having a thickness of 1 mm at an incident angle of less than 10 degrees. Electrical leads 27 are connected to electrodes 20 and 30 to supply a voltage thereto. Furthermore, the tungsten electrode is typically coated with a mixture of alkaline earth oxides to enhance electron emission. A layer 50 of particles of at least a selected phosphor is deposited on the inner surface of the glass envelope to absorb the radiation emitted by the discharge. In addition a layer 40 of scattering particles can be deposited between the inner wall of glass envelope 10 and phosphor layer 50 to enhance light extraction. Glass envelope 10 is evacuated and then charged with an inert gas, such as argon, at a pressure up to about 4000 Pa. Other inert gases, such as neon, krypton, and xenon, also may be used. In addition, one or more gases that are capable of generating at least one of the radicals disclosed above when such gases are bombarded by charged species of the discharge are disposed in the glass tube at a pressure up to about 2 torr (or 267 Pa). The tube is sealed and is then ready for use.

In another embodiment, the electrical discharge that provides charged species for generating excited mercury-free charged radicals of the present invention is generated by an induction coil at high frequency. The coil generates a high-frequency magnetic field, which produces a magnetically induced plasma discharge. Such a source of discharge has been put into practice in electrodeless discharge lamps. For example, U.S. Pat. Nos. 4,262,231; 5,952,791; 5,959,405; 6,051,922; and 6,137,236; which are incorporated herein by reference, show various embodiments of electrodeless discharge lamps. One or more of the materials, which are listed in Table 1 above, that can generate excited radical species when bombarded by other species of the plasma, which excited radical species emit EM radiation in the UV range upon returning to a less excited state, can be used as a component of the filling gas in such electrodeless lamps to practice the present invention. Frequencies in the range of greater than about 2 MHz, preferably greater than about 2.5 MHz, can be used to generate the magnetically induced plasma discharge.

While various embodiments are described herein, it will be appreciated from the specification that various combinations of elements, variations, equivalents, or improvements therein may be made by those skilled in the art, and are still within the scope of the invention as defined in the appended claims.

What is claimed is:

1. A gas discharge comprising:
an inert gas selected from the group consisting of argon, neon, krypton, xenon, and mixtures thereof, said inert gas being capable of generating charged species; and
at least a first radical-producing material that is capable of generating at least a first radical selected from the group consisting of nitrogen-containing radicals, carbon-containing radicals, and mixtures thereof, said at least a first radical being generated by a bombardment of said material with said charged species;
wherein said gas discharge emits electromagnetic (“EM”) radiation having wavelengths in a range from about 254 nm to about 410 nm.

2. The gas discharge according to claim 1, further comprising a second radical-producing material capable of generating an oxygen-containing radical.

3. The gas discharge according to claim 1, wherein said at least a first radical is selected from the group consisting of CO, CO⁺, CO₂⁺, CN, CN⁺, NH, NO, N₂O⁺, and C₂.

4. The gas discharge according to claim 2, wherein said oxygen-containing radical comprises OH, and at least a first radical is selected from the group consisting of CO, CO⁺, CO₂⁺, CN, CN⁺, NH, N₂O⁺, and C₂.

5. A discharge lamp comprising an optically transparent envelope filled with:
(a) at least an inert gas selected from the group consisting of argon, neon, krypton, xenon, and mixtures thereof, said inert gas being capable of generating charged species; and
(b) at least a first radical-producing material that is capable of generating at least a first radical selected from the group consisting of nitrogen-containing radicals, carbon-containing radicals, and mixtures thereof, said at least a first radical being generated by a bombardment of said material with said charged species;
wherein said at least a first radical emits electromagnetic (“EM”) radiation having wavelengths in a range from about 254 nm to about 410 nm.

6. The discharge lamp according to claim 5, wherein said envelope is further filled with a second radical-producing material capable of generating an oxygen-containing radical.

7. The discharge lamp according to claim 5, wherein said at least a first radical is selected from the group consisting of CO, CO⁺, CO₂⁺, CN, CN⁺, NH, NO, N₂O⁺, and C₂.

8. The discharge lamp according to claim 6, wherein said oxygen-containing radical comprises OH, and said at least a first radical is selected from the group consisting of CO, CO⁺, CO₂³⁰ , CN, CN⁺, NH, NO, N₂O⁺, and C₂.

9. A fluorescent lamp comprising:
(a) an optically transparent enveloped filled with:
(1) at least an inert gas selected from the group consisting of argon, neon, krypton, xenon, and mixtures thereof, said inert gas being capable of generating charged species; and
(2) at least a first radical-producing material that is capable of generating at least a first radical selected from the group consisting of nitrogen-containing radicals, carbon-containing radicals, and mixtures thereof; said at least a radical being generated by a bombardment with said charged species; said at least a first radical being capable of emitting first EM radiation having wavelengths in a range from about 254 nm to about 410 nm; and
at least a phosphor disposed on an inner wall of said enveloped, said phosphor absorbing at least a portion of said first EM radiation and emitting second EM radiation having wavelengths in a visible spectrum.

10. The fluorescent lamp according to claim 9, wherein said envelope is further filled with a second radical-producing material capable of generating an oxygen-containing radical.

11. The fluorescent lamp according to claim 9, wherein said at least a first radical is selected from the group consisting of CO, CO⁺, CO₂⁺, CN, CN⁺, NH, NO, N₂O⁺, and C₂.

12. The fluorescent lamp according to claim 10, wherein said oxygen-containing radical comprises OH, and said at least a first radical is selected from the group consisting of CO, CO⁺, CO₂⁺, CN, CN⁺, NH, NO, N₂O⁺, and C₂.

13. The fluorescent lamp according to claim 9, wherein said at least a phosphor is selected from the group consisting of (Sr,Ca)₁₀(PO₄)₆Cl₂:Eu²⁺; Sr₂P₂O₇:Eu²⁺; (Sr,Mg)₂P₂O₇:Eu²⁺; Ba_{0.07}Mg₂Al_{z}O_{3/2z+3}:Eu_{0.13}²⁺, where 14≦z≦25; 2SrO.0.84P₂O₅.0.16B₂O₃:Eu²⁺; Sr₂Si₃O₈.2SrCl₂:Eu²⁺; Sr₄Al₄O₂₅:Eu²⁺; Ba_{0.8}Mg_{1.93}Al₁₆O₂₇:Eu_{0.2}²⁺,Mn²⁺; Y₂SiO₅:Ce³⁺,Tb³⁺; 6MgO.As₂O₅:Mn⁴⁺; and 3.5MgO.0.5MgF₂.GeO₂:Mn⁴⁺.

14. The fluorescent lamp according to claim 9, wherein said charged species are generated by an action of an electrical discharge on said at least an inert gas.

15. The fluorescent lamp according to claim 14, wherein said electrical discharge is generated by applying a voltage to a pair of electrodes.

16. The fluorescent lamp according to claim 14, wherein said electrical discharge is generated by a high frequency magnetic field, which is generated by an induction coil.

17. A method for generating visible light, said method comprising:
providing an EM radiation source emitting first EM radiation having a wavelength in a range from about 254 nm to about 410 nm, wherein said providing said EM radiation source comprises generating excited radicals comprising at least one element selected from the group consisting of nitrogen, carbon, and combinations thereof, and said excited radicals emits said EM radiation upon returning to a lower energy state
disposing at least a photoluminescent material to receive at least a portion of said first EM radiation, said photoluminescent material being capable of absorbing said at least a portion of said first EM radiation and emitting a second EM radiation in a visible wavelength range.

18. The method according to claim 17, wherein said excited radicals further comprises oxygen.
